(19) United States
(12) Patent Application Publication
(10) Pub. No.: US 2014/0097174 A1
(43) Pub. Date: Apr. 10, 2014

(54) HEAT TREATMENT FURNACE AND METHOD OF REPLACING HEATER OF SAME

(71) Applicants: Kazuhiko KATSUMATA, Inuyama-shi (JP); Takahisa SHIMADA, Kagamihara-shi (JP)

(72) Inventors: Kazuhiko KATSUMATA, Inuyama-shi (JP); Takahisa SHIMADA, Kagamihara-shi (JP)

(21) Appl. No.: 14/104,751

(22) Filed: Dec. 12, 2013

Related U.S. Application Data
(63) Continuation of application No. PCT/JP2012/065259, filed on Jun. 14, 2012.

(30) Foreign Application Priority Data
Jun. 16, 2011 (JP) 2011-133996

(51) Int. Cl. F27D 11/02; B23P 6/00; H05B 3/08

(52) U.S. Cl. CPC F27D 11/02; H05B 3/08; B23P 6/00
USPC 219/424; 219/507; 29/402.08

(57) ABSTRACT

A heat treatment furnace (10) used to perform heat treatment on a treatment target (1) includes a hollow heating chamber (20) in which the treatment target is housed and which is formed of a heat insulating member, a resistance heater (22) that is mounted in the heat insulating member, a hollow furnace body (12) that is spaced apart from the heating chamber by a gap and surrounds the heating chamber, a nozzle (16) that is provided to the furnace body so as to communicate with an interior of the furnace body, an electrode bar (30) that is removably mounted on an outer end of the nozzle and is electrically insulated from the nozzle, and a flexible conducting wire (32) that electrically connects a lead wire (23) of the heater and the electrode bar. The conducting wire (32) can be attached to and detached from the electrode bar (30) outside the nozzle (16) while the electrode bar (30) is separated from the nozzle (16), and has such a length that it does not come into contact with the inner surface of the nozzle while the electrode bar is mounted thereon.

### TECHNICAL FIELD

The present invention relates to a heat treatment furnace used to perform heat treatment on a treatment target and a method of replacing a heater of the same.

Priority is claimed on Japanese Patent Application No. 2011-133996, filed on Jun. 16, 2011, the content of which is incorporated herein by reference.

### BACKGROUND ART

A resistance heater is installed in a heat treatment furnace, which performs heat treatment on an object to be treated, in order to heat the object to be treated. Such a heat treatment furnace is disclosed in, for instance, Patent Document 1, and the resistance heater is disclosed in, for instance, Patent Document 2. Hereinafter, the resistance heater is simply referred to as a “heater.”

Patent Document 1 discloses a heat treatment furnace that is a single chamber type vacuum heat treatment furnace and includes a box-shaped insulator installed in a furnace body and a heater provided in the box-shaped insulator so as to surround a part to be treated.

Patent Document 2 discloses a heater system in which a lead wire of a heater and an electrode part are directly joined.

### DOCUMENT OF RELATED ART

### Patent Document

[Patent Document 1] Japanese Unexamined Patent Application, First Publication No. 2009-216344

[Patent Document 2] Japanese Unexamined Patent Application, First Publication No. 2007-040837

### SUMMARY OF INVENTION

### Technical Problem

The lead wire of the heater used in the heat treatment furnace is required to be electrically connected to an electrode bar exposed to an exterior of the heat treatment furnace and to supply power from the exterior through the electrode bar. Conventionally, the lead wire and the electrode bar are joined by direct brazing, but they are connected together using a connector.

However, since the heater is exposed to a high temperature when used, service life thereof is short, and the heater needs to be replaced. In this case, the conventional connecting means described above has the following problems.

(1) When joined by the direct brazing, it is necessary to perform unjoining and rejoining works of a joint in the heat treatment furnace. These works are performed in a narrow space in the heat treatment furnace. For this reason, workability is bad, and the works require time and effort. Further, the quality checking of the joint is difficult, and the reliability of the quality is low.

(2) When connected using the connector, it is necessary to perform decoupling and recoupling works of the connector. These works are also performed in a narrow space in the heat treatment furnace. For this reason, the workability is bad, and the works require time and effort.

(3) When a heating chamber mounting a heater is provided in the heat treatment furnace, it is necessary to remove the entire heating chamber mounting the heater to the outside in order to replace the heater. In this case, the connector is large in structure and has no flexibility. Further, a gap between a furnace body and the heating chamber is small. For this reason, it is difficult to remove the entire heating chamber to the outside.

The present invention has been made in consideration of these circumstances, and an object of the present invention is to provide a heat treatment furnace, in which a lead wire in the furnace and an externally exposed electrode bar outside the furnace can be easily attached and detached, and even when a gap between a furnace body and a heating chamber mounting the heater is small, the entire heating chamber can be easily removed to the outside, and a method of replacing a heater of the same.

### Solution to Problem

In a first aspect relating to the present invention, a heat treatment furnace used to perform heat treatment on a treatment target includes: a hollow heating chamber in which the treatment target is housed and which is formed of a heat insulating member; a resistance heater that is mounted in the heat insulating member; a hollow furnace body that is spaced apart from the heating chamber by a gap and surrounds the heating chamber; a nozzle that is provided to the furnace body so as to communicate with an interior of the furnace body; an electrode bar that is removably mounted on an outer end of the nozzle and is electrically insulated from the nozzle; and a flexible conducting wire that electrically connects a lead wire of the heater and the electrode bar.

The conducting wire is attachable to and detachable from the electrode bar outside the nozzle in a state in which the electrode bar is separated from the nozzle, and has such a length that the conducting wire does not come into contact with an inner surface of the nozzle in a state in which the electrode bar is mounted on the nozzle.

In a second aspect relating to the present invention, a method for replacing the heater with which the heat treatment furnace relating to the first aspect is equipped, the method includes the following processes:

(A) separating the conducting wire from the electrode bar outside the nozzle in the state in which the electrode bar is separated from the nozzle;

(B) opening an upper portion of the furnace body;

(C) moving the heating chamber to an opposite side of the nozzle in the furnace body in a state in which the conducting wire is connected to the lead wire, and moving the lead wire and the conducting wire from an interior of the nozzle; and

(D) removing the heating chamber from the upper portion of the furnace body to the outside with the conducting wire connected to the lead wire.

In this case, the conducting wire is attachable to and detachable from the electrode bar outside the nozzle in the state in which the electrode bar is separated from the nozzle, and has such a length that the conducting wire does not come into contact with an inner surface of the nozzle in the state in which the electrode bar is mounted on the nozzle.

Further, in the state in which the conducting wire is connected to the lead wire, the heating chamber moves to an opposite side of the nozzle in the furnace body, and the lead wire and the conducting wire move from an interior of the nozzle into the furnace. The heating chamber is removed from the upper portion of the furnace body to the outside. Accordingly, even when a gap between the furnace body and the heating chamber mounting the heater is small, the entire heating chamber can be easily removed to the outside.

As a result, the heater can be mounted outside the furnace, and the attaching/detaching operation is easily performed even in a narrow work space. For this reason, maintenance is improved. Further, the entire heating chamber can be easily, rapidly removed to the outside, and the heater can be replaced externally.

### Effects of Invention

According to the present invention, the heat treatment furnace and the method for replacing the heater can be provided in which the lead wire in the furnace and the externally exposed electrode bar can be easily attached and detached outside the furnace, and even when the gap between the furnace body and the heating chamber mounting the heater is small, the entire heating chamber can be easily removed to the outside.

### BRIEF DESCRIPTION OF DRAWINGS

FIG. 1 is a longitudinal sectional view showing a heat treatment furnace in a first embodiment of the present invention.

FIG. 2 is a cross-sectional view taken along line II-II of FIG. 1.

FIG. 3 is a view taken in the direction of arrows of FIG. 1.

FIG. 4 is a view taken in the direction of arrows IV-IV of FIG. 1.

FIG. 5 is a first process view showing a method of replacing a heater of the heat treatment furnace in the first embodiment of the present invention.

FIG. 6 is a second process view showing the method of replacing the heater of the heat treatment furnace in the first embodiment of the present invention.

### DESCRIPTION OF EMBODIMENTS

Hereinafter, exemplary embodiments of the present invention will be described with reference to the drawings. Note that in each drawing, common portions will be given the same reference numerals, and a duplicate description thereof will be omitted here.

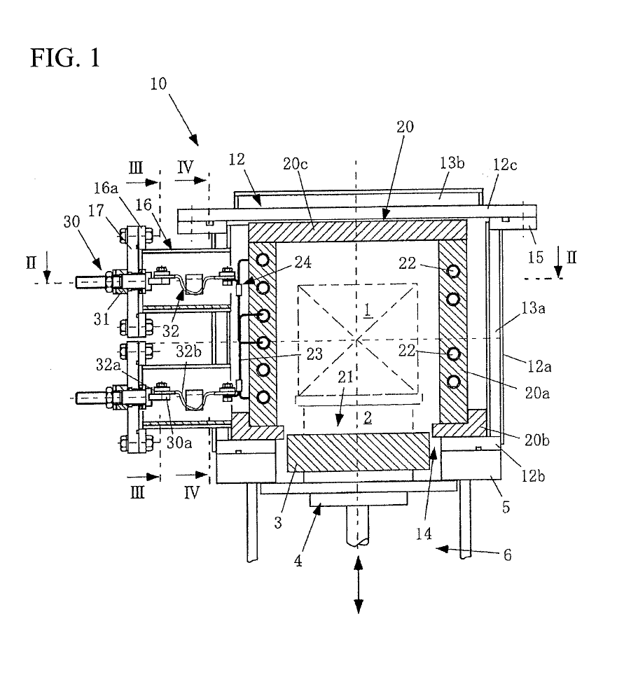

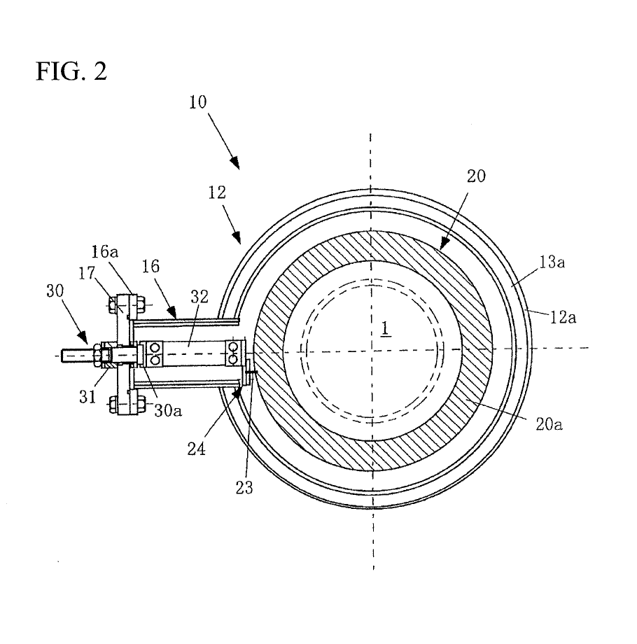

FIG. 1 is a longitudinal sectional view showing a heat treatment furnace in the present embodiment. FIG. 2 is a cross-sectional view taken along line II-II of FIG. 1.

In the present embodiment, a heat treatment furnace 10 is a vacuum heat treatment furnace that performs heat treatment on a treatment target 1. In the present invention, the heat treatment furnace 10 is not limited to the vacuum heat treatment furnace, and may be another heat treatment furnace as long as it can perform the heat treatment on the treatment target 1.

In FIGS. 1 and 2, the heat treatment furnace 10 includes a furnace body 12 and a heating chamber 20.

The furnace body 12 is a hollow airtight container. In the present embodiment, the furnace body 12 has a hollow cylindrical furnace body frame 12a whose axial center is perpendicular, a furnace body base 12b blocking a lower surface of the furnace body frame 12a, and a furnace body cover 12c blocking an upper surface of the furnace body frame 12a.

The furnace body frame 12a is provided with a water-cooling jacket 13a of a double structure on an outer circumferential surface thereof Cooling water is supplied from a supply port (not shown) into the water-cooling jacket 13a and cools the entire furnace body frame 12a.

The furnace body base 12b is a circular flat plate whose outer edge is connected to a lower end of the furnace body frame 12a. Further, a lower side of the furnace body base 12b is connected to a separate lower vacuum treatment chamber 6 via a flange 5.

In the present embodiment, the flange 5 has a water-cooling jacket (not shown) of a double structure. Cooling water is supplied from a supply port (not shown) into the water-cooling jacket and cools the entire flange 5.

The furnace body base 12b is provided with a circular opening 14 in a central portion thereof. The untreated object 1 can be inserted from the lower vacuum treatment chamber 6 into the heat treatment furnace 10 through the opening 14, and be unloaded to the outside.

In FIG. 1, a support member 2 supports the treatment target 1, and a heat insulator 3 supports the support member 2 and blocks the opening 14. A liftable stand 4 can raise and lower the treatment target 1, the support member 2, and the heat insulator 3, and close the opening 14.

A constitution of the liftable stand 4 is not limited to that of the present embodiment. The liftable stand 4 having another constitution may insert the treatment target 1 into the heat treatment furnace 10 and unload the treatment target 1 to the outside.

The furnace body frame 12a is provided with a flange 15 at an upper end thereof.

The furnace body cover 12c is a circular flat plate whose outer edge is removably connected to the flange 15 of the furnace body frame 12a. Further, the furnace body cover 12c has a water-cooling jacket 13b of a double structure. Cooling water is supplied from a supply port (not shown) into the water-cooling jacket 13b and cools the entire furnace body cover.

The heating chamber 20 is a hollow heat-insulating container. In the present embodiment, the heating chamber 20 includes a hollow cylindrical heating chamber frame 20a whose axial center is perpendicular, a heating chamber base 20b supporting a lower surface of the heating chamber frame 20a, and a heating chamber cover 20c blocking an upper surface of the heating chamber frame 20a.

The heating chamber frame 20a, the heating chamber base 20b, and the heating chamber cover 20c are formed of a certain heat-resistant heat-insulating member. The certain heat-resistant heat-insulating member has heat resistance that is resistant to a highest temperature (e.g. 1000° C.) of the heater, and is formed of a heat-insulating material having low thermal conductivity.

The heating chamber frame 20a has an integral hollow cylindrical shape, and a resistance heater 22 is mounted in the heat-insulating member thereof.

In the present embodiment, two spiral heaters 22 are buried in the heat-insulating member of the heating chamber frame 20a, and only lead wires 23 thereof are exposed outside the heating chamber frame 20a.

The heating chamber base 20b is a circular flat plate having a circular opening 21 consistent with the opening 14. Further, an outer edge of the heating chamber base 20b is adjacent to an inner surface of the furnace body frame 12a. Furthermore, an upper surface of the heating chamber base 20b has a step, at the center of which a lower end of the heating chamber frame 20a is located, and an outer circumferential surface of the heating chamber frame 20a is spaced apart from the inner surface of the furnace body frame 12a by a predetermined gap.

The predetermined gap is set to such a length that the heating chamber frame 20a of the heating chamber 20 can be removed from an upper portion of the furnace body 12 to the outside with a conducting wire connected to the lead wires 23.

In FIGS. 1 and 2, the heat treatment furnace 10 is equipped with a nozzle 16, an electrode bar 30, and a conducting wire 32.

The nozzle 16 is installed on the furnace body 12 so as to communicate with the interior of the furnace body 12. Further, the nozzle 16 is provided with a nozzle flange 16a at an outer end thereof.

In the present embodiment, the nozzle 16 is two upper and lower horizontal nozzles, and is installed on the furnace body frame 12a of the furnace body 12 in a penetrated state.

The nozzle 16 is not limited thereto, and may be inclined or vertical. Further, the nozzle 16 may be installed on the heating chamber base 20b or the heating chamber cover 20c of the furnace body 12.

The electrode bar 30 is removably mounted on an outer end of the nozzle 16, and is electrically insulated from the nozzle 16.

In the present embodiment, the electrode bar 30 is connected to the nozzle flange 16a, blocks an opening of the outer end of the nozzle 16, and is mounted on a flange 17 via an insulator 31 in a penetrated state. The flange 17 is a blind flange in the present embodiment, but may be another flange.

Further, the electrode bar 30 is provided with a connecting terminal 30a at an inner end thereof which connects the conducting wire 32 using a bolt.

The conducting wire 32 has flexibility and is electrically connected to the lead wire 23 of the heater 22 and the electrode bar 30.

In the present embodiment, the conducting wire 32 has a flat part 32b that electrically connects connecting terminals 32a of opposite ends thereof between the connecting terminals 32a. The term “flat” means that the width is greater than the thickness.

The flat part 32b is, for instance, a flat-knitted wire 32b. The flat-knitted wire 32b is formed of a plurality of conductive wires, and a cross section thereof is formed in a flat plate shape by knitting the plurality of conductive wires.

Further, the conducting wire 32 is removably connected to the electrode bar 30 outside the nozzle 16 in a state in which the electrode bar 30 is separated from the nozzle 16, and has a length at which it does not come into contact with an inner surface of the nozzle in a state in which the electrode bar 30 is mounted on the nozzle 16.

The conducting wire 32 is not limited to the aforementioned constitution, and may have flexibility. The conducting wire 32 may be another flexible cable.

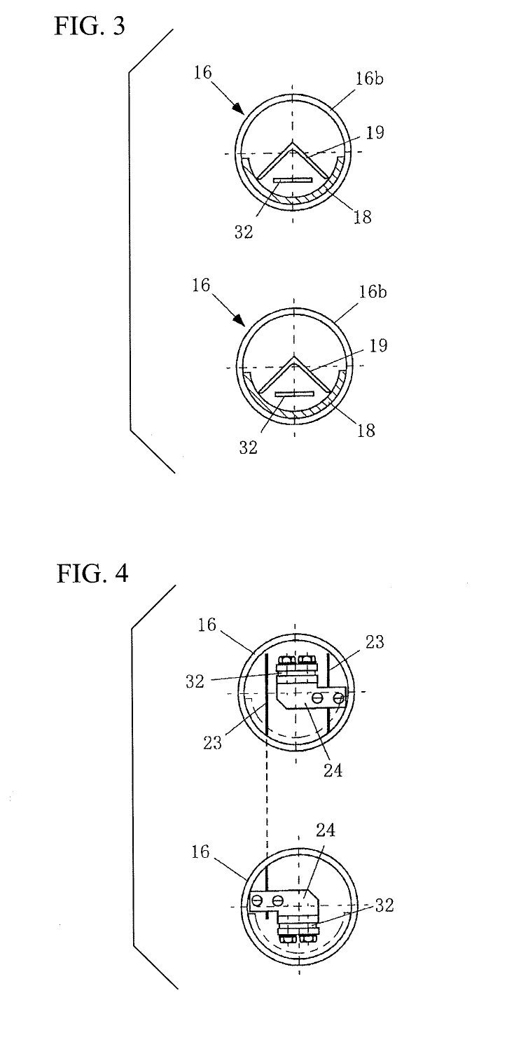

FIG. 3 is a view taken in the direction of arrows of FIG. 1.

As shown in FIG. 3, the nozzle 16 includes a hollow pipe 16b that has a heat-radiating outer surface from which heat is externally radiated and is made of a metal, and an insulation part 18 that partly covers an inner surface of the hollow pipe 16b.

The insulation part 18 is located between the inner surface of the nozzle and the conducting wire 32 in a state in which the electrode bar 30 is mounted on the nozzle 16.

With this constitution, heat is outwardly radiated from the heat-radiating outer surface of the hollow pipe 16b, the inner surface of which is not covered with the insulation part 18, so as to prevent an interior of the nozzle from being overheated.

In the present embodiment, the nozzle 16 is the horizontal nozzle, and the insulation part 18 covers a lower side of the horizontal nozzle.

Further, in FIG. 3, to inhibit the conducting wire 32 from moving to the inner surface of the hollow pipe 16b which is not covered with the insulation part 18, a movement restricting member 19 is provided.

The conducting wire 32 is located between the movement restricting member 19 and the insulation part 18.

In the present embodiment, the movement restricting member 19 is a member that is located so as not to be in contact with the conducting wire 32 and has an L-shaped cross section. When the nozzle 16 is horizontal, and the insulation part 18 is located at the lower side of the nozzle, a weight (not shown) may be directly loaded onto the conducting wire 32.

With this constitution, the conducting wire 32 can be inhibited from clattering, and the conducting wire 32 can be prevented from coming into contact with a conductive portion of the inner surface of the nozzle.

FIG. 4 is a view taken in the direction of arrows IV-IV of FIG. 1.

As shown in FIG. 4, a conducting wire fixing plate 24 is fixed to the lead wire 23 of the heater 22, and the connecting terminal 32a of the inner side of the conducting wire 32 is connected to the conducting wire fixing plate 24 by a bolt.

With the aforementioned constitution of the heat treatment furnace 10, in the state in which the electrode bar 30 is separated from the nozzle 16, the conducting wire 32 has such a length that the electrode bar 30 can be attached or detached outside the nozzle 16. As such, as the flange 17 is separated from the nozzle flange 16a, a part of the conducting wire 32 can be pulled out toward the exterior of the nozzle 16, and the connecting terminal 32a of the conducting wire 32 and the connecting terminal 30a inside the electrode bar 30 can be easily attached or detached outside the furnace.

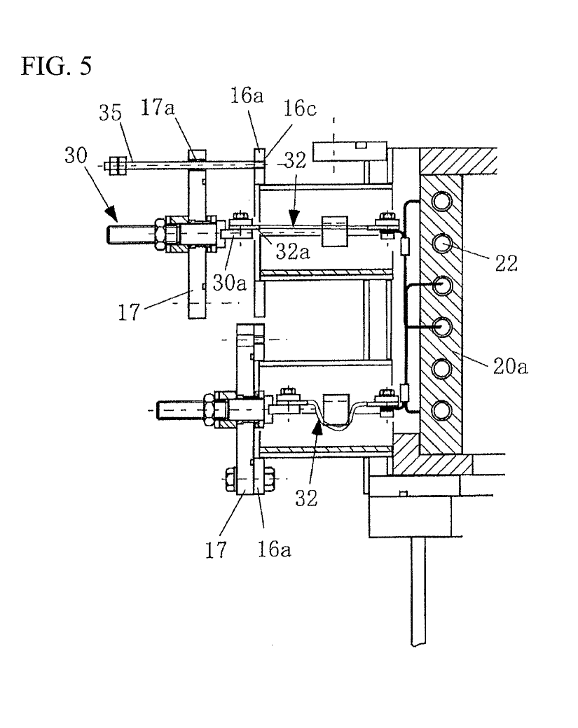

FIG. 5 is a first process view showing a method of replacing a heater of the heat treatment furnace in the first embodiment of the present invention.

In FIG. 5, the nozzle flange 16a of the nozzle 16 is provided with female thread holes 16c parallel with the electrode bar 30.

Further, the flange 17 is provided with through-holes 17a, which have a larger diameter than the female thread holes 16c, at positions facing the female thread holes 16c of the nozzle flange 16a.

A method of replacing the heater in the present embodiment begins using the aforementioned heat treatment furnace 10, and the conducting wire 32 is separated from the electrode bar 30 outside the nozzle 16 in the state in which the electrode bar 30 is separated from the nozzle 16.

That is, the flange 17 is separated from the nozzle flange 16a. Thereby, a part of the conducting wire 32 is pulled out toward the exterior of the nozzle 16, and the connecting terminal 32a of the conducting wire 32 and the connecting terminal 30a inside the electrode bar 30 are separated outside the furnace.

In a first process, guide bars 35 are inserted through the through-holes 17a of the flange 17, and male threads formed at a tip of each guide bar 35 are screwed to each female thread hole 16c of the nozzle flange 16a. Thereby, the guide bars 35 can be fixed in parallel with the electrode bar 30.

Further, to prevent the flange 17 from deviating and falling down, a nut is installed on the tip of the guide bar 35.

Next, the flange 17 slides along the guide bars 35 and is separated from the nozzle 16. Thereby, weight of the flange 17 is supported by the guide bars 35. As such, workability of the first process can be improved, and time and effort can be reduced.

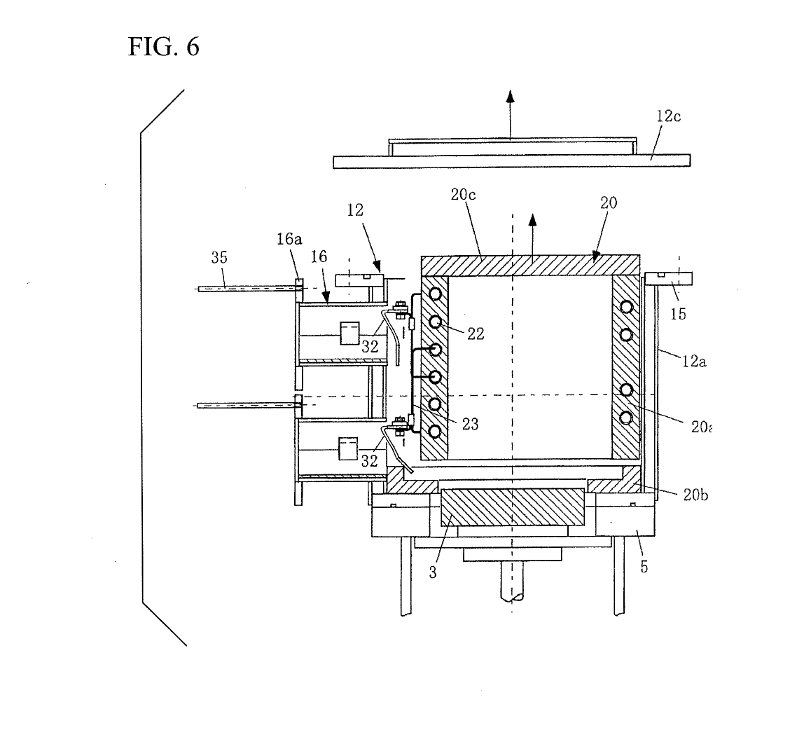

FIG. 6 is a second process view showing the method of replacing the heater of the heat treatment furnace in the first embodiment of the present invention.

First, the upper portion of the furnace body 12 is opened. In detail, the upper portion of the furnace body 12 is opened by separating the furnace body cover 12c from the flange 15 of the furnace body frame 12a, and demounting the furnace body cover 12c.

This process may be performed before or after the first process described above.

Next, in the state in the conducting wire 32 is connected to the lead wire 23, the heating chamber 20 is moved in the furnace body 12 toward the opposite side of the nozzle 16 (in the rightward direction in the figure), and the lead wire 23 and the conducting wire 32 are moved from the interior of the nozzle 16 into the furnace body 12.

Due to this movement, the lead wire 23 and the conducting wire 32 can be moved to an inner side of the furnace body frame 12a.

Subsequently, in the state in the conducting wire 32 is connected to the lead wire 23, the heating chamber 20 is removed from the upper portion of the furnace body 12 to the outside. In this case, the lead wire 23 and the conducting wire 32 are located inside the furnace body frame 12a. Thereby, the entire heating chamber 20 can be hoisted by a crane with the conducting wire 32 connected to the lead wire 23, and be moved to the outside. Then, the heater 22 is replaced outside.

After the heater 22 is replaced, the aforementioned second process is performed in the reverse order, and the heating chamber 20 is installed in the furnace body 12. The aforementioned first process is performed in the reverse order again. Thereby, the heat treatment furnace 10 can be assembled in its original state.

According to the aforementioned method, in the state in which the electrode bar 30 is separated from the nozzle 16, the conducting wire 32 has such a length that the electrode bar 30 can be attached or detached outside the nozzle 16. For this reason, as the flange 17 is separated from the nozzle flange 16a, a part of the conducting wire 32 is pulled out toward the exterior of the nozzle 16, and the connecting terminal 32a of the conducting wire 32 and the connecting terminal 30a inside the electrode bar 30 can be easily attached or detached outside the furnace.

Further, in the state in which the conducting wire 32 is connected to the lead wire 23, the heating chamber 20 is moved in the furnace body 12 toward the opposite side of the nozzle 16, and the lead wire 23 and the conducting wire 32 are moved from the interior of the nozzle 16 into the furnace body 12. The heating chamber 20 is removed from the upper portion of the furnace body 12 to the outside. For this reason, even when the gap between the furnace body 12 and the heating chamber 20 mounting the heater 22 is small, the entire heating chamber can be easily removed to the outside.

Accordingly, the heater 22 can be mounted outside the furnace, and the attaching/detaching operation is easily performed even in a narrow work space. For this reason, maintenance is improved. Further, the entire heating chamber can be easily, rapidly removed to the outside, and the heater can be replaced outside. Further, the heating chamber 20 may be an angled heating chamber.

While exemplary embodiments of the present invention have been described with reference to the drawings, the present invention is not limited to these embodiments. All the forms and combinations of the components shown in the aforementioned embodiments are merely one example, and can be modified based on design requirements without departing from the gist of the present invention.

### INDUSTRIAL APPLICABILITY

According to the present invention, the heat treatment furnace and the method of replacing the heater can be provided in which the lead wire in the furnace and the externally exposed electrode bar can be easily attached and detached outside the furnace, and even when the gap between the furnace body and the heating chamber mounting the heater is small, the entire heating chamber can be easily removed to the outside.

### DESCRIPTION OF REFERENCE SIGNS

1 treatment target,
10 heat treatment furnace,
12 furnace body,
16 nozzle,
16a nozzle flange,
16b hollow pipe,
16c female thread hole,
17 flange,
17a through-hole,
18 insulation part,
19 movement restricting member,
20 heating chamber,
22 heater,
23 lead wire,
30 electrode bar,
32 conducting wire,
35 guide bars

1. A heat treatment furnace, which performs heat treatment on a treatment target, comprising:
a hollow heating chamber in which the treatment target is housed and which is formed of a heat insulating member;
a resistance heater that is mounted in the heat insulating member;
a hollow furnace body that is spaced apart from the heating chamber by a gap and surrounds the heating chamber;
a nozzle that is provided to the furnace body so as to communicate with an interior of the furnace body;
an electrode bar that is removably mounted on an outer end of the nozzle and is electrically insulated from the nozzle; and
a flexible conducting wire that electrically connects a lead wire of the heater and the electrode bar,
wherein the conducting wire is attachable to and detachable from the electrode bar outside the nozzle in a state in which the electrode bar is separated from the nozzle, and has such a length that the conducting wire does not come into contact with an inner surface of the nozzle in a state in which the electrode bar is mounted on the nozzle.

2. The heat treatment furnace according to claim 1, wherein the conducting wire has a flat part.

3. The heat treatment furnace according to claim 1, wherein the nozzle includes a hollow pipe that has a heat-radiating outer surface from which heat is externally radiated and is made of a metal, and an insulation part that partly covers an inner surface of the hollow pipe.

4. The heat treatment furnace according to claim 3, wherein:
a movement restricting member is provided to inhibit the conducting wire from moving to the inner surface of the hollow pipe which is not covered with the insulation part; and
the conducting wire is located between the movement restricting member and the insulation part.

5. A method of replacing the heater with which the heat treatment furnace according to claim 1 is equipped, the method comprising:
(A) separating the conducting wire from the electrode bar outside the nozzle in the state in which the electrode bar is separated from the nozzle;
(B) opening an upper portion of the furnace body;
(C) in a state in which the conducting wire is connected to the lead wire, moving the heating chamber to an opposite side of the nozzle in the furnace body, and moving the lead wire and the conducting wire from an interior of the nozzle into the furnace body; and
(D) removing the heating chamber from the upper portion of the furnace body to an outside with the conducting wire connected to the lead wire.

6. The method of replacing the heater according to claim 5, wherein:
the nozzle has a nozzle flange having hole parts at an outer end thereof;
the electrode bar is mounted on a flange connected to the nozzle flange via an insulator;
the flange has through-holes communicating with the hole parts of the nozzle flange when the flange and the nozzle flange are connected; and
the process (A) includes inserting guide bars into the through-holes of the flange and the hole parts of the flange, and sliding the flange along the guide bars to separate the flange from the nozzle.

7. The heat treatment furnace according to claim 2, wherein the nozzle includes a hollow pipe that has a heat-radiating outer surface from which heat is externally radiated and is made of a metal, and an insulation part that partly covers an inner surface of the hollow pipe.

8. The heat treatment furnace according to claim 7, wherein:
a movement restricting member is provided to inhibit the conducting wire from moving to the inner surface of the hollow pipe which is not covered with the insulation part; and
the conducting wire is located between the movement restricting member and the insulation part.
